(19) United States
(12) Patent Application Publication
(10) Pub. No.: US 2019/0197820 A1
(43) Pub. Date: Jun. 27, 2019

(54) VIRTUAL SLOT BANK FOR MULTIPLE PLAYERS

(71) Applicant: IGT, Las Vegas, NV (US)

(72) Inventors: Scott Caputo, Fremont, CA (US); Fayez Idris, Dieppe, CA (US)

(21) Appl. No.: 15/852,401

(22) Filed: Dec. 22, 2017

(51) Int. Cl. G07F 17/32

(52) U.S. Cl. CPC G07F 17/3211; G07F 17/3239; G07F 17/323; G07F 17/3267; G07F 17/3288; G07F 17/3223; G07F 17/3274; G07F 17/3255; G07F 17/3227; G07F 17/3206; G07F 17/3295

(57) ABSTRACT

A computer implemented method includes providing a real-time environmental model of a shared virtual environment (SVE) that includes multiple virtual electronic wagering game machines (vEGMs), transmitting VR data corresponding to the SVE to a virtual reality (VR) device that is associated with a player. The VR data includes user display data that causes a display in the VR device to render a portion of the SVE based on an orientation of the VR device and a location of the VR device in the SVE. The method includes receiving, from the VR device, tracking information that is generated by multiple sensors that are configured to provide information corresponding to the player, and responsive to receiving the tracking information, transmitting updated VR data that causes the display to display a virtual interaction with one of the vEGMS in the SVE.

### COPYRIGHT NOTICE

A portion of the disclosure of this patent document contains or may contain material that is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### FIELD

Embodiments described herein relate to virtual reality systems and methods, and in particular to virtual reality systems and methods for use in connection with gaming.

### BACKGROUND

Electronic and electro-mechanical gaming machines (EGMs) are systems that allow users to place a wager on the outcome of a random event, such as the spinning of mechanical or virtual reels or wheels, the playing of virtual cards, the rolling of mechanical or virtual dice, the random placement of tiles on a screen, etc. Advances in technology have significantly changed the characteristics of products offered by the gambling industry and associated effects on user experiences. Virtual reality gaming involves using an innovative 3-D computer-based format with high resolution graphics the totally immerses the player into an interactive gaming environment. Virtual reality technologies may enable innovative and highly immersive player experience.

### SUMMARY

A computer implemented method according to some embodiments includes providing a real-time environmental model of a shared virtual environment (SVE) that includes multiple virtual electronic wagering game machines (vEGMs). Operations include transmitting VR data corresponding to the SVE to a virtual reality (VR) device that is associated with a player. The VR data may include user display data that causes a display in the VR device to render a portion of the SVE based on an orientation of the VR device and a location of the VR device in the SVE. Operations may include receiving, from the VR device, tracking information that is generated by multiple sensors that are configured to provide information corresponding to the player and responsive to receiving the tracking information, transmitting updated VR data that causes the display to display a virtual interaction with one of the vEGMS in the SVE.

In some embodiments, multiple players play respective ones of the vEGMs via the tracking information. The players are represented in the SVE by avatars and the VR device includes a microphone and a speaker that provide 2 way audio communication between the players while playing the vEGMs in the SVE.

Some embodiments provide that the tracking information includes data corresponding to a direction that a corresponding one of the players is facing within the SVE and that the VR data causes the display to display a visual image of one or more of the avatars in the SVE based on the tracking information.

In some embodiments, in response to one of the players triggering a bonus round in one of the vEGMS in the SVE, other ones of the players are caused to be in the bonus round with the one that triggered the bonus round. In some embodiments, which other ones of the players are included in the bonus round is determined based on at least one of an amount of wagering during a given time period before the bonus is triggered, a random selection, and a player tracking score corresponding to wagering activity of the respective one of the players.

In some embodiments, the SVE includes a bonus SVE that is provided to each of the players in the bonus round via the VR device. Some embodiments provide that the bonus SVE corresponds to a theme of the vEGM that the player triggering a bonus game was playing when the bonus round was triggered. In some embodiments, the bonus SVE includes a maze that each of the players in the bonus SVE can cause their avatars to navigate using an input device that is associated with the VR device. Some embodiments provide that the bonus SVE includes a bonus vEGM that is hidden in the maze, that visual and audio communication is provided between each of the players in the bonus SVE to collaborate with one another to locate the bonus vEGM that is hidden in the maze.

In some embodiments, responsive to any of the players in the bonus SVE locating the bonus vEGM that is hidden in the maze, each of the players in the bonus SVE are awarded games to play on the vEGM for a given time. Some embodiments provide that locating the bonus vEGM that is hidden in the maze includes the avatar performing at least one of opening a door in the maze, ducking below an overhanging object in the maze, jumping onto an elevated surface in the maze, climbing a vertical structure in the maze, breaking through a wall in the maze, and falling into a hole structure in the maze.

In some embodiments, the maze is generated responsive to the bonus round being triggered. Some embodiments provide that the difficulty of the maze is based on at least one of a payout potential of the bonus vEGM and the number of players in the bonus round.

Some embodiments provide that the bonus vEGM includes multiple vEGMS that are hidden at different locations in the maze and that the quantity of the vEGMS that are hidden in the maze is based on the number of players in the bonus round.

Some embodiments include generating, within the SVE, audible and/or visual cues to ones of the players in the bonus round based on the location of the player's avatar in the maze relative to the location of the bonus vEGM in the maze. Some embodiments include generating virtual objects that are in the maze and that the players may interact with via the respective avatars. Some embodiments provide that the virtual objects may include at least one of avatar attire, a tool, a weapon, a vehicle, a time extension award, and a maze modifier.

In some embodiments, the different players are each located at different geographical locations from one another and the different geographical locations include different premises types. For example, a first player may be in a first geographical location that includes a first premises type that is one of a residence, a casino, a restaurant, and an office building, and a second player is in a second geographical location that includes a second premises type that is one of a residence, a casino, a restaurant, and an office building that is different from the first premises type.

Some embodiments provide that one of the players is interacting with one of the vEGMS in the SVE via a communication channel between the VR device of the player and a computing device of a casino. In some embodiments, different ones of the avatars include different attributes and/or skills that may be performed in the SVE.

Some embodiments disclosed herein include a system for providing a multi-player wagering game. The system includes a memory, a communication interface that is communicatively coupled to a virtual reality (VR) device, and a processor that is coupled to the memory and the communication interface. The processor is configured to provide an environmental model of a shared virtual environment (SVE) that includes virtual electronic wagering game machines (vEGMs), transmit VR data corresponding to the SVE to the VR device that is associated with a player, the VR data including user display data causes a display in the VR device to render a portion of the SVE based on an orientation of the VR device and a location of the VR device in the SVE, receive, from the VR device, tracking information that is generated by sensors that are configured to provide information corresponding to the player, and responsive to receiving the tracking information, transmit updated VR data that causes the display to display a virtual interaction with one of the vEGMS in the SVE.

Some embodiments disclosed herein include a non-transitory computer readable medium that includes instructions configured to cause a processing device to execute methods of providing a multi-player wagering game according to operations disclosed herein.

It is noted that aspects of the invention described with respect to one embodiment, may be incorporated in a different embodiment although not specifically described relative thereto. That is, all embodiments and/or features of any embodiment can be combined in any way and/or combination. These and other objects and/or aspects of the present invention are explained in detail in the specification set forth below.

### BRIEF DESCRIPTION OF THE DRAWINGS

The accompanying figures are included to provide a further understanding of the present inventive concept, and are incorporated in and constitute a part of this specification. The drawings illustrate some embodiments of the present inventive concept and, together with the description, serve to explain principles of the present inventive concept.

FIG. 1 is a schematic block diagram illustrating a network configuration for a plurality of gaming devices according to some embodiments.

FIG. 2 is a block diagram that illustrates various components of an VR device 200 according to some embodiments.

FIG. 3 is a schematic diagram illustrating a view of multiple players in a shared virtual environment (SVE) according to some embodiments.

FIG. 4 is a top view of a bonus SVE that is generated as a maze according to some embodiments.

FIG. 5 is a schematic view of a player in a three-dimensional maze according to some embodiments.

FIG. 6 is a flowchart illustrating operations of systems/methods according to some embodiments.

FIG. 7, which is a block diagram that illustrates various components of an VR controller 70 according to some embodiments.

FIG. 8 is a flow diagram illustrating message flows according to some embodiments.

### DETAILED DESCRIPTION

Embodiments of the inventive concepts provide systems and methods for providing a real-time environmental model of a shared virtual environment (SVE) that includes multiple virtual electronic waging game machines (vEGMs). The SVE may include audio, visual, and tactile content that multiple players can experience together via virtual reality devices. For example, the vEGMS may be arranged in the SVE as a bank of vEGMs that different players can interact with via their respective VR devices. Additionally, the players can interact with one another in the SVE via the VR devices. Although players are adjacent one another in the SVE, players may be accessing the SVE using their respective VR devices from locations that are adjacent one another and/or in different geographical locations. For example, one player may be in a casino, another player may be at a different place in a casino and yet another player may be in a location that is different than the casino, for example, at home or in a non-casino location.

In addition to interacting with one another in the SVE while playing the vEGMs, when a player achieves a bonus round, the player may be transported into a bonus SVE that includes different visual, audible and/or tactile content. In some embodiments, the bonus SVE may include a two- or three-dimensional maze that the player may move through with the goal of finding a bonus vEGM that can be played for a chance at winning bonus rewards. Some embodiments provide in addition to the player that triggers the bonus round, some or all of the other players in the SVE may be transported into the bonus SVE. The players may work together in a cooperative manner to find the bonus vEGM. Once the bonus vEGM is found, all to the players in the bonus SVE may play the bonus vEGM.

When interacting with the SVE, players may be visually represented to other players by an avatar or other graphical object that represents the player. As used herein, when a player is referred to as performing some task and/or operation in the SVE, it will be understood that the player is providing an input that causes the player's corresponding avatar to perform the task and/or operation in the SVE. These and other embodiments are discussed in detail below.

Virtual Reality EGM Systems and Viewers

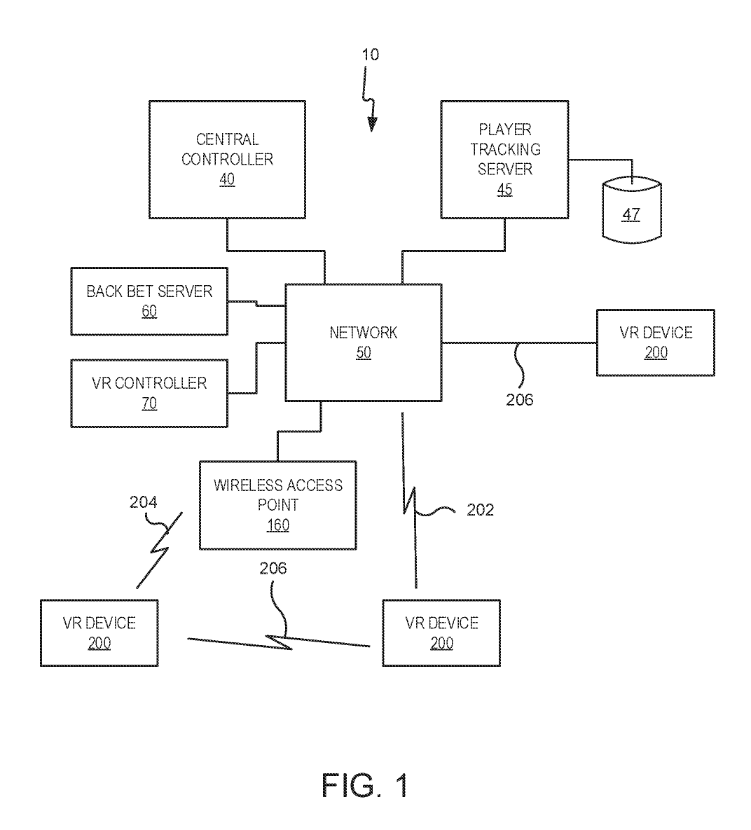

Referring to FIG. 1, a gaming system 10 is illustrated. The gaming system 10 may be located, for example, on the premises of a gaming establishment, such as a casino. System components may be in communication with each other and/or at least one central controller 40 through a data network or remote communication link 50. The data communication network 50 may be a private data communication network that is operated, for example, by the gaming facility. Communications over the data communication network 50 may be encrypted for security. The central controller 40 may be any suitable server or computing device which includes at least one processor and at least one memory or storage device. The processor of the central controller 40 is configured to transmit and receive events, messages, commands or any other suitable data or signal between the central controller 40 and any of the other system components. In some embodiments, one or more of the functions of one or more other system components as disclosed herein may be performed by the central controller 40.

A wireless access point 160 provides wireless access to the data communication network 50. The wireless access point 160 may be connected to the data communication network 50 as illustrated in FIG. 1, or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, a virtual reality (VR) device 200 is provided. The VR device 200 communicates with one or more elements of the system 10 to render two-dimensional (2D) and/or three-dimensional (3D) content that corresponds to a shared virtual environment (SVE) to one or more players. That is, the VR device 200 provides virtual images corresponding to the SVE to the players. In some embodiments, the VR device 200 may be further configured to enable the player to interact with virtual objects displayed to the player by the VR device 200.

The VR device 200 communicates with one or more elements of the system 10 to coordinate the rendering of virtual reality images, sounds, and/or tactile outputs that correspond to the SVE to the player. For example, in some embodiments, the VR device 200 may communicate directly with the network 50 (and the devices connected thereto) over a wireless interface 202, which may be a WiFi link, a Bluetooth link, an NFC link, etc. In some embodiments, the VR device 200 may communicate directly with the network 50 (and the devices connected thereto) over a wired interface 206. In other embodiments, the VR device 200 may communicate with the data communication network 50 (and devices connected thereto) over a wireless interface 204 with the wireless access point 160. The wireless interface 204 may include a WiFi link, a Bluetooth link, an NFC link, etc. In still further embodiments, multiple VR devices 200 may communicate simultaneously with the network 50 (and devices connected thereto) over the wireless interface 202, the wireless access point 160 over the wireless interface 204 and/or the wired interface 206. In these embodiments, the wireless interface 202, the wireless interface 204 and the wired interface 206 may use different communication protocols and/or different communication resources, such as different frequencies, time slots, spreading codes, etc. For example, in some embodiments, the wireless interface 202 may be a Bluetooth link, while the wireless interface 204 may be a WiFi link.

The interfaces 202, 204, 206 allow the VR device 200 to coordinate the generation and/or rendering of virtual reality images, sounds, and/or tactile outputs to multiple different players via corresponding VR devices 200.

In some embodiments, the gaming system 10 includes a virtual reality controller, or VR controller 70. The VR controller 70 may be a computing system that communicates through the data communication network 50 with the VR devices 200 to coordinate the generation and rendering of virtual reality images, sounds and/or tactile outputs to one or more players using the VR devices 200. The VR controller 70 may be implemented within or separately from the central controller 40.

In some embodiments, the VR controller 70 may coordinate the generation and display of the virtual images of the same virtual object to more than one player by more than one VR device 200. As described in more detail below, this may enable multiple players to interact with the same virtual object and with each other together in real time in the SVE. This feature can be used to provide a shared multiplayer experience to multiple players at the same time.

Moreover, in some embodiments, the VR controller 70 may coordinate the generation and display of the same virtual object, sound and/or tactile output to players that are at different physical locations, as will be described in more detail below.

The VR controller 70 may generate and/or store a three dimensional wireframe map of a gaming area, such as a casino floor, that includes multiple vEGMS and may provide the three dimensional wireframe map to the VR devices 200. The wireframe map may store various information about the vEGMs in the SVE, such as the identity, type and relative location of the vEGMs. The three-dimensional wireframe map may enable an VR device 200 to more quickly and accurately determine its position and/or orientation within the SVE, and may enable the VR device 200 to assist the player in navigating the SVE while using the VR device 200. The generation of three-dimensional wireframe maps is described in more detail below.

In some embodiments, at least some processing of virtual images, objects, sounds and/or tactile outputs that are rendered by the VR devices 200 may be performed by the VR controller 70, thereby offloading at least some processing requirements from the VR devices 200.

A back bet server 60 may be provided to manage back bets placed using a VR device 200 as described in more detail below. A VR device 200 may communicate with the back bet server 60 through the wireless interface 204 and network 50.

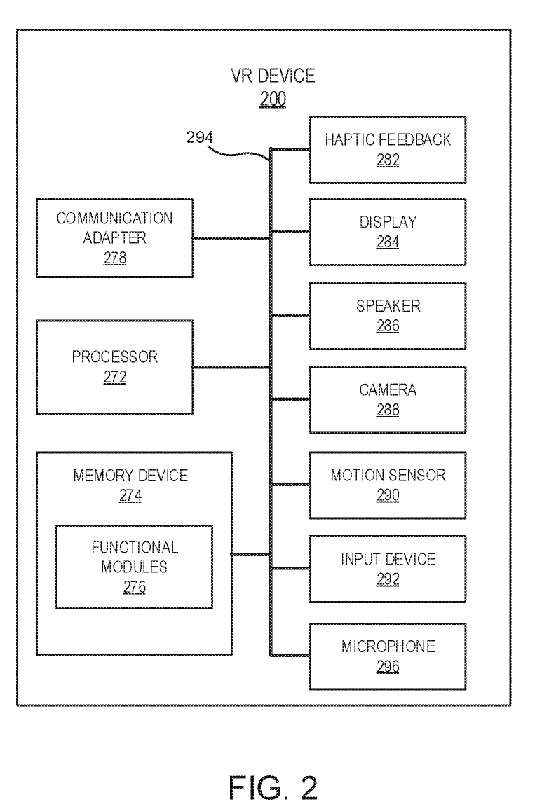

Reference is now made to FIG. 2, which is a block diagram that illustrates various components of an VR device 200 according to some embodiments. As shown in FIG. 2, the VR device 200 may include a processor 272 that controls operations of the VR device 200. Although illustrated as a single processor, multiple special purpose and/or general purpose processors and/or processor cores may be provided in the VR device 200. For example, the VR device 200 may include one or more of a video processor, a signal processor, a sound processor and/or a communication controller that performs one or more control functions within the VR device 200. The processor 272 may be variously referred to as a “controller,” “microcontroller,” “microprocessor” or simply a “computer.” The processor 272 may further include one or more application-specific integrated circuits (ASICs).

Various components of the VR device 200 are illustrated in FIG. 12 as being connected to the processor 272. It will be appreciated that the components may be connected to the processor 272 and/or each other through one or more busses 294 including a system bus, a communication bus and controller, such as a USB controller and USB bus, a network interface, or any other suitable type of connection.

The VR device 200 further includes a memory device 274 that stores one or more functional modules 276 for performing the operations described above.

The memory device 274 may store program code and instructions, executable by the processor 272, to control the VR device 200. The memory device s74 may include random access memory (RAM), which can include non-volatile RAM (NVRAM), magnetic RAM (ARAM), ferroelectric RAM (FeRAM) and other forms as commonly understood in the gaming industry. In some embodiments, the memory device 274 may include read only memory (ROM). In some embodiments, the memory device 274 may include flash memory and/or EEPROM (electrically erasable programmable read only memory). Any other suitable magnetic, optical and/or semiconductor memory may operate in conjunction with the gaming device disclosed herein.

The VR device 200 may include a communication adapter 278 that enables the VR device 200 to communicate with remote devices, such as the wireless network 50, another VR device 200, and/or a wireless access point 160 (FIG. 1) over a wired and/or wireless communication network, such as a local area network (LAN), wide area network (WAN), cellular communication network, or other data communication network.

The VR device 200 may include one or more internal or external communication ports that enable the processor 272 to communicate with and to operate with internal or external peripheral devices, such as displays 284, speakers 286, cameras 288, sensors, such as motion sensors 290, input devices 292, such as keyboards, pointer devices, and/or keypads, mass storage devices, microphones 296, haptic feedback devices 282 and wireless communication devices. In some embodiments, internal or external peripheral devices may communicate with the processor through a universal serial bus (USB) hub (not shown) connected to the processor 272. Although illustrated as being integrated with the VR device 200, any of the components therein may be external to the VR device 200 and may be communicatively coupled thereto. Although not illustrated, the VR device 200 may further include a rechargeable and/or replaceable power device and/or power connection to a main power supply, such as a building power supply.

In some embodiments, the VR device 200 may include a head mounted device (HMD) and may include optional wearable add-ons that include one or more sensors and/or actuators, including ones of those discussed herein. In some embodiments, the VR device 200 may be a head-mounted augmented-reality (AR) (also referred to as mixed-reality) device configured to provide elements of the SVE as part of a real-world scene being viewed by the player wearing the VR device 200. An AR display may provide sensory indication that the player perceives as being associated with a location in a real-world scene in a field of view of the player.

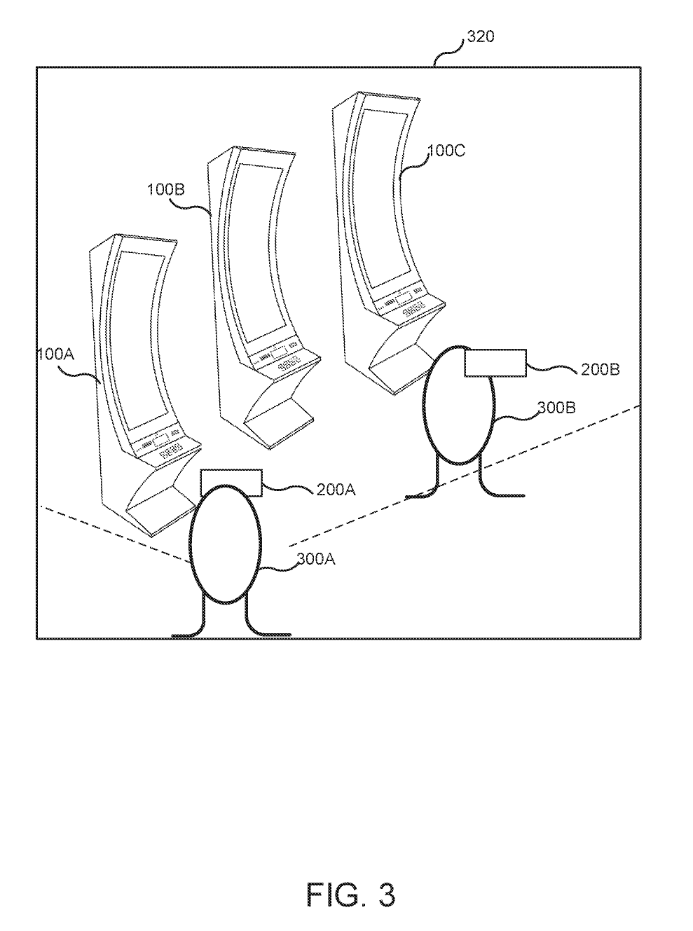

Reference is now made to FIG. 3, which is a schematic diagram illustrating a view of multiple players in a shared virtual environment (SVE) according to some embodiments. As illustrated, the SVE 320 is a virtual environment that is provided to the players 300 via the VR devices 200. Within the SVE 320, the players 300 may be represented by avatars or other virtual objects. The players 300 may communicate with other players 300 in the SVE 320 in real-time. For example, a first player 300A may talk to a second player 300B during the shared experience in the SVE 320. Some embodiments provide the player 300 may see each other in the SVE 320 by virtue of their respective avatars.

The SVE 320 may include a plurality of virtual electronic wagering game machines (vEGMs) 100 that may be played by the players 300 in the SVE 320. The VR devices 200 may include inputs for the players 300 to interact with and play the vEGMS 100. A player 300 may hear and see another player 300 playing a vEGM 100 in the SVE 320. While the players 300 are playing together virtually in the SVE 320, in reality, each of the players 300 may be in completely different geographical locations. For example, among players 300 that are playing vEGMS 100 together in the SVE 320, one player 300A may be in a casino while another player 300B may be at his or her home that may be at a different address from the casino and/or in a different city, state, country and/or continent.

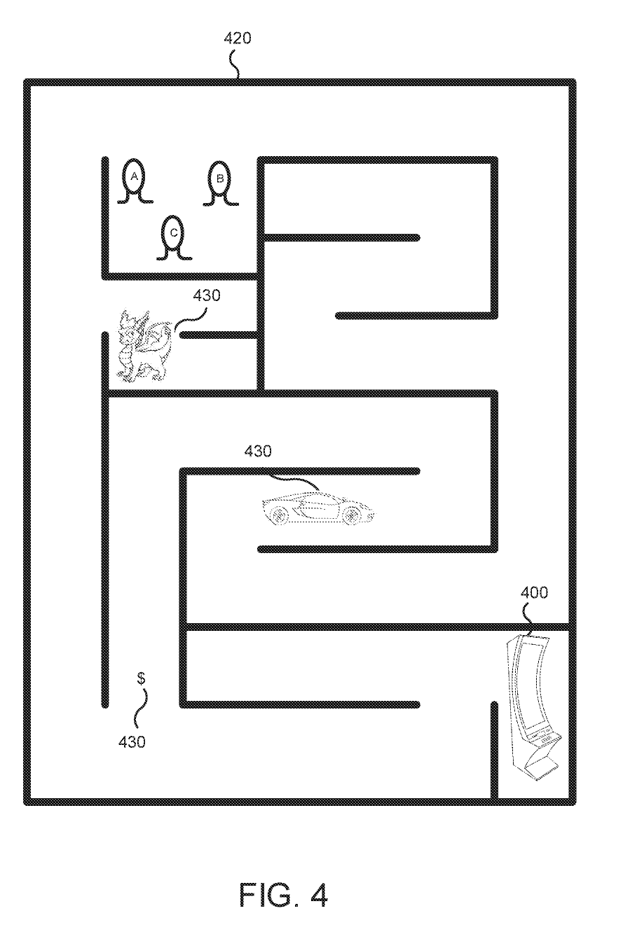

Some embodiments provide that when one of the players 300 triggers a bonus round on the eVGM 100 that the player 300 is playing in the SVE 320, the VR controller 70 may transport the player 300 into a bonus SVE that is different than the SVE 320. For example, reference is now made to FIG. 4, which is a top view of a bonus SVE that is generated as a maze 420. The maze 420 may be a three-dimensional maze that the player (via their avatar) may explore. For example, the maze may be a three-dimensional maze 420 that the player may navigate from a first person perspective by providing user inputs via the VR device 200.

Examples of user inputs for the VR device 200 that may be used for moving within the maze include buttons, a directional indicator such as a joystick or the like, body and/or motion and/or position detectors, including control inputs that may be integrated into gloves or other devices that may worn by the player 300. A player 300 may use a controller and/or buttons on gloves to move forward in the direction they are facing, which may be determined based on other control inputs to control which direction the player 300 is facing. In some embodiments, a player 300 may traverse the maze 420 by physically stepping while wearing their virtual reality gear and by turning their body left or right to change directions.

In some embodiments, the maze 420 may include a bonus virtual electronic wagering game machine (vEGM) 400 that may be in an undisclosed location relative to the players 300. For example, the bonus vEGM 400 may be hidden in the maze 420. In some embodiments, the vEGM 400 may look like a real physical slot machine and may include slot machine titles that are physically produced in the real (non-virtual) world. Some embodiments provide that one or more of the players 300 know which machine will be the bonus vEGM 400 in the bonus SVE. In some embodiments, the bonus vEGM 400 is unknown to any of the player 300 and/or is not based on any real-world game titles.

Some embodiments provide that the maze 420 includes a number of rooms, hallways, courtyards, doors, stairs, and other such features. The theme of the maze 420 may be tied to any theme including a theme unique to a particular EGM, unique to a casino operator, and/or unique to a licensed property, such as an entertainment industry franchise.

As illustrated in FIG. 4, the players 300A-C may begin in the same general area or room of the maze 420 when the bonus round begins. In this regard, the players 300A-C may work together to navigate the maze 420 in a cooperative effort to locate the hidden bonus vEGM 400. Some embodiments provide that the players 300A-C may start in different location in the maze 420 relative to one another. In such embodiments, the players 300 may communicate with one another to try to determine their locations relative to other players 300 by describing landmarks in the maze 420 or other features. In some embodiments, the maze 420 is a dynamic maze that includes one or more doors, windows, trapdoors, floors and/or walls that may move and/or be moved by the players 300.

In some embodiments, the players 300 may receive clues regarding their locations relative to the hidden bonus vEGM 400. For example, the VR device 200 may produce sounds that correspond to the bonus vEGM 400 and that indicate a particular direction relative to a player 300. Some embodiments provide that such clues may be visual clues such as a glowing area corresponding to the direction of the bonus vEGM 400.

In some embodiments, the bonus vEGM 400 is hidden in the maze 420 at the same place every time and is the same machine. In some other embodiments, the system randomly chooses a machine type and/or machine location within the maze 420.

In some embodiments, the maze 420 may include virtual objects 430 that the players collect and/or interact with. For example, virtual objects 430 may include avatar attire that may be an upgrade relative to the initial attire of an avatar. The upgrade may be a visual improvement and/or a functional improvement that provides the avatar with increased and/or additional capabilities, such as speed, jumping, climbing, flying, etc. In some embodiments, the virtual object 430 may be a new avatar that the player steps into when the player interacts with the virtual object in the maze 420.

Some embodiments provide that the virtual object 430 include an object that the avatar may pick up and use to improve and/or increase functionality in the maze 420. For example, the object may include a tool, a weapon, a vehicle, a time extension award, credit/monetary award and/or a maze modifier, such as a way to move and/or remove barriers or walls. For example, players 300 may find small cash prizes that they may win individually and/or to be shared with the other players in a pool.

Players 300 may be assigned similar and/or different avatars in the maze 420. In some embodiments, the avatars may have different shapes and/or sizes and may have different unique special abilities and/or limitations. For example, a dwarf avatar may let the player 300 scurry through small openings, a giant avatar may have the ability to break down locked doors, a dragon avatar may have the ability to fly up to far away ledges. In some embodiments, a player 300 may choose their avatar and the avatar may have no effect on game play.

Certain challenges in the maze 420 may only be accomplished if multiple players 300 participate. For example, a particular door might have multiple levers which require multiple players to open.

Some embodiments provide that once a player 300 touches the bonus vEGM 400 in the maze 420, each of the players may have a predetermined amount of time to play the bonus vEGM 400. Playing the bonus vEGM 400 may be quite lucrative, so the more quickly the players can find the hidden bonus vEGM 400, the more time they may have to try to win. Some embodiments provide that the amount of time the players 300 have to find the bonus vEGM 400 may be determined by how the bonus was triggered, by the number of players 300 in the maze 420, by the richness or level of awards of the hidden slot machine, and/or by any other suitable method. In some embodiments, the player 300 who first touches the hidden bonus vEGM 400 may receive an extra award such as more spins or plays, a multiplier (e.g. 2X), more player tracking points and/or any other suitable reward. In some embodiments, all cash prizes collected by all the players 300 are shared by all of the players 300.

In some embodiments, a player 300 may be given the opportunity to customize their maze 420. For example, the choice may be based on a desired level of volatility in which a player may choose between less time to or a larger maze find a more lucrative bonus vEGM 400 or more time or a smaller maze to find less lucrative bonus vEGM 400. Additionally, the choice may be a thematic choice such as a choice among Medieval, Mayan, Egyptian, Outer Space, Zombie Warehouse, etc. Some embodiments provide that new types of challenges may be provided to the players 300 so that the maze challenge can stay interesting.

In some embodiments, the bonus SVE may include a leaderboard that shows the fastest time that previous teams have found the bonus vEGM 400. Some embodiments provide that the fastest times may be eligible for and extra reward. After the bonus round, the leaderboard may show all players where the bonus vEGM 400 was located in the maze 420 and what path they could have taken to find it. Players 300 may still win a consolation prize. In some embodiments, if a bonus vEGM 400 is not found in one bonus round, the next bonus round may include an extra bonus vEGM 400 to be found.

In some embodiments, a group bonus round may provide that ones of the players 300 may chase another player 300 if that player is chosen and achieves a certain bonus and/or award level or threshold. Some embodiments provide that some players 300 tagging a target player may claim/share a part of the level achieved by the target player. In this manner, distribution of levels achieved by the target player may provide increased levels for some or all of the other players 300.

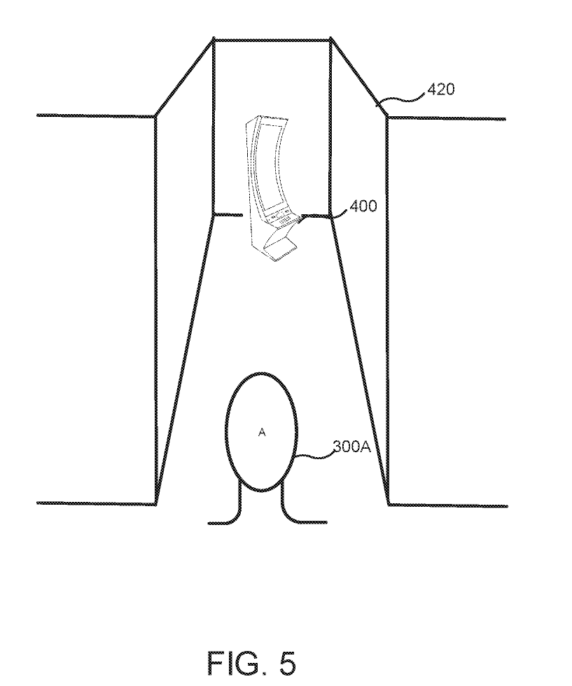

Brief reference is made to FIG. 5, which is a schematic view of a player 300 in a maze 420 according to some embodiments. As illustrated, the maze 420 includes the bonus vEGM 400 at the end of one of the illustrated corridor of the maze 420.

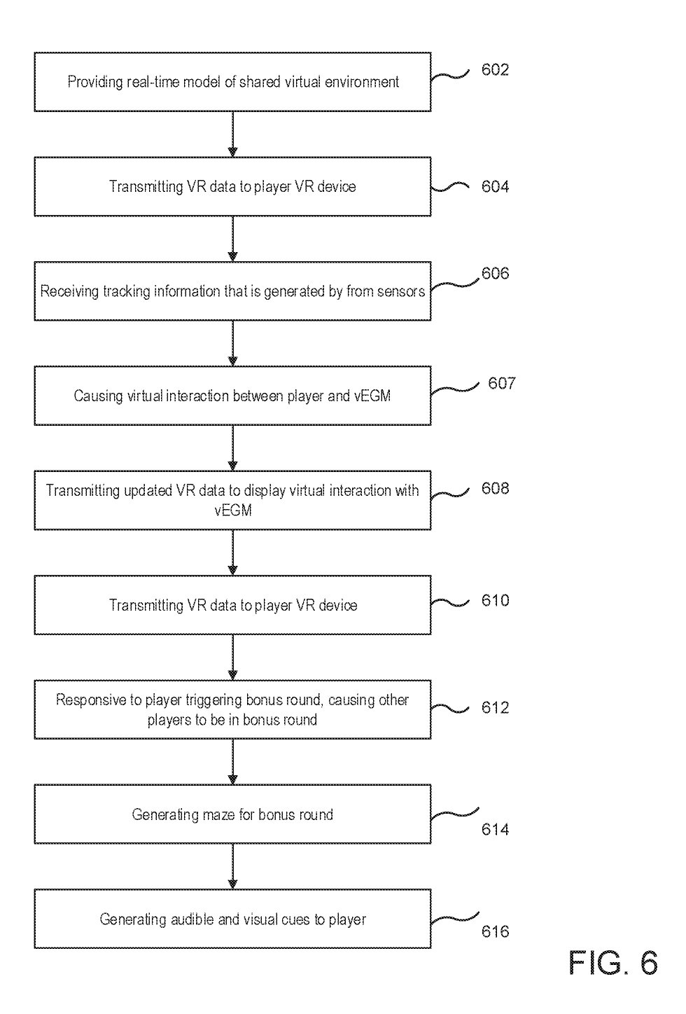

Reference is now made to FIG. 6, which is a flowchart illustrating operations of systems/methods according to some embodiments. Operations may include providing a real-time environmental model of a shared virtual environment (SVE) (block 602). Some embodiments provide that the SVE includes multiple virtual electronic wagering game machines (vEGMs). For example, vEGMS may include virtual expressions corresponding to electronic wagering game machines (EGMs) that physically exist and may be playable in one or more casinos. In some embodiments, the vEGMs may be wholly fictitious in that there are no real-world versions of the particular vEGM. The vEGMs may be arranged in a group of machines that may be played by different players at the same time in the SVE. Detailed feature of vEGMs according to some embodiments are described below.

Operations may include transmitting VR data corresponding to the SVE to a virtual reality (VR) device that is associated with a player (block 604). Some embodiments provide that the VR data includes user display data that causes a display in the VR device to render a portion of the SVE based on an orientation of the VR device and a location of the VR device in the SVE. For example, some embodiments provide that multiple players can play different multiple instances of vEGMS in the SVE at the same time. In some embodiments, the players are represented in the SVE by respective avatars. Some embodiments provide that the players may interact with one another via the VR devices. For example, VR devices may include a microphone and a speaker that provide 2-way audio communication between different players while playing the vEGMs in the SVE.

Operations may include receiving, from the VR device, tracking information that is generated by a plurality of sensors that are configured to provide information corresponding to the player (block 606). Some embodiments provide that the tracking information includes data corresponding to a direction that a player is facing within the SVE. Operations may include causing a virtual interaction between the player and a vEGM based on the tracking information (block 607).

Operations include, responsive to receiving the tracking information, transmitting updated VR data that causes the display to display a virtual interaction with one of the vEGMS in the SVE (block 608). In some embodiments, the VR data may be transmitted to the VR device (block 610). The VR data may cause the display to display a visual image of one or more of the avatars in the SVE based on the tracking information.

Some embodiments provide that, responsive to one of the players triggering a bonus round in their vEGMS in the SVE, causing other of the players to be in the bonus round with the player that triggered the bonus round (block 612). In some embodiments, determining which other players are included in the bonus round is determined based on at least one of an amount of wagering during a given time period before the bonus is triggered, a random selection, and a player tracking score corresponding to wagering activity of the respective one of the plurality of players.

Some embodiments provide that the SVE includes a bonus SVE that is provided to the players in the bonus round via the VR device. In some embodiments, the bonus SVE corresponds to a theme of the vEGM that the one of the players triggering a bonus game was playing when the bonus round was triggered.

In some embodiments, the bonus SVE includes a maze that each of the players in the bonus SVE can cause their respective avatars to navigate using an input device that is associated with the VR device. 19. In some embodiments, different avatars may include different attributes and/or skills that may be performed in the SVE.

Some embodiments provide that maze may be generated (block 614), while other embodiments provide that the maze pattern is selected from among a list of stored maze patterns.

In some embodiments, the bonus SVE includes a bonus vEGM that is hidden in the maze. Some embodiments provide that visual and audio communication is provided between each of the of players in the bonus SVE to collaborate with one another to locate the bonus vEGM that is hidden in the maze. In response to any player in the bonus SVE locating the bonus vEGM that is hidden in the maze, each of the players in the bonus SVE may be awarded games to play on the vEGM for a given time. In this regard, the more quickly the players can find the hidden vEGM, the more time they may have to win additional awards in the bonus round.

Some embodiments provide that locating the bonus vEGM that is hidden in the maze requires an avatar to perform at least one of opening a door in the maze, ducking below an overhanging object in the maze, jumping onto an elevated surface in the maze, climbing a vertical structure in the maze, breaking through a wall in the maze, and falling into a hole structure in the maze. In some embodiments, the VR device may provide a haptic feedback to the player responsive to certain actions and/or environmental conditions and/or events. Some embodiments provide that the difficulty of the maze may be based on at least one of a payout potential of the bonus vEGM and the number of players in the bonus round. For example, a maze with a relatively large number of players may be made more difficult than one with fewer players.

In some embodiments, the difficulty may be varied by providing more than one bonus vEGMs that are hidden at different locations in the maze. For example, the quantity of vEGMS hidden in the maze may be negatively correlated with the number of player in the bonus round. In some embodiments, audible and/or visual cues may be generated for one or more players based on the location of the player avatars relative to the bonus vEGM in the maze. For example, a glowing light may emanate from the direction of the vEGM or sounds may be generated to come from the direction of the vEGM in the maze.

In some embodiments, the maze may be populated with virtual objects including clues, tools, avatar attire, weapons, vehicles, time extension awards, cash awards and/or a maze modifier, among others. Some embodiments provide that the virtual objects may be used to assist the players in finding the hidden bonus vEGM. For example, special attire such as a flying suit, fast shoes, or increased strength may be available. Weapons may be used to eliminate or subdue active threats in the maze, such as worms that make the floor slick or snakes that block an entrance or passageway. In some embodiments, tools such as hammers, keys, drills, etc. may be used to unlock or overcome obstacles or barriers in the maze. Vehicles may provide increased speed in traversing the maze and/or may allow the player to overcome obstacle such as water (e.g., boats or submarines) or canyons or walls (e.g., aircraft). Tools may include dynamite for blasting down doors or removable walls.

Some embodiments provide the players are each located at different geographical locations from one another. While players may be in a casino while playing in the SVE, players are not so limited. For example, players may play from home or any other type of premises than a casino. Additionally, a group of players playing in the SVE may be located in different locations and/or types thereof.

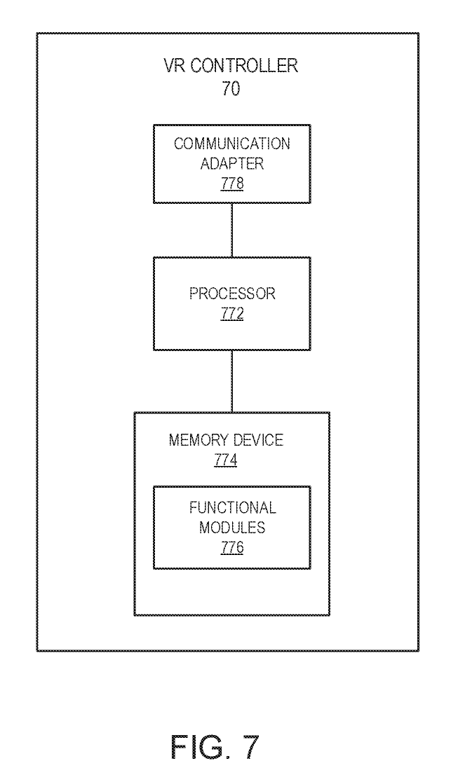

Reference is now made to FIG. 7, which is a block diagram that illustrates various components of an VR controller 70 according to some embodiments. As shown in FIG. 7, the VR controller 70 may include a processor 772 that controls operations of the VR controller 70. Although illustrated as a single processor, multiple special purpose and/or general purpose processors and/or processor cores may be provided in the VR controller 70. For example, the system may include one or more of a video processor, a signal processor, a sound processor and/or a communication controller that performs one or more control functions. The processor 772 may be variously referred to as a “controller,” “microcontroller,” “microprocessor” or simply a “computer.” The processor may further include one or more application-specific integrated circuits (ASICs).

Various components of the VR controller 70 are illustrated in FIG. 7 as being connected to the processor 772. It will be appreciated that the components may be connected to the processor 772 through a system bus, a communication bus and controller, such as a USB controller and USB bus, a network interface, or any other suitable type of connection.

The VR controller 70 further includes a memory device 774 that stores one or more functional modules 776 for performing the operations described above.

The memory device 774 may store program code and instructions, executable by the processor 772, to control the VR controller 70. The memory device 774 may include random access memory (RAM), which can include non-volatile RAM (NVRAM), magnetic RAM (ARAM), ferroelectric RAM (FeRAM) and other forms as commonly understood in the gaming industry. In some embodiments, the memory device 774 may include read only memory (ROM). In some embodiments, the memory device 774 may include flash memory and/or EEPROM (electrically erasable programmable read only memory). Any other suitable magnetic, optical and/or semiconductor memory may operate in conjunction with the gaming device disclosed herein.

The VR controller 70 may include a communication adapter 778 that enables the VR controller 70 to communicate with remote devices, such as VR devices and/or a player tracking server 45 (FIG. 1) over a wired and/or wireless communication network, such as a local area network (LAN), wide area network (WAN), cellular communication network, or other data communication network.

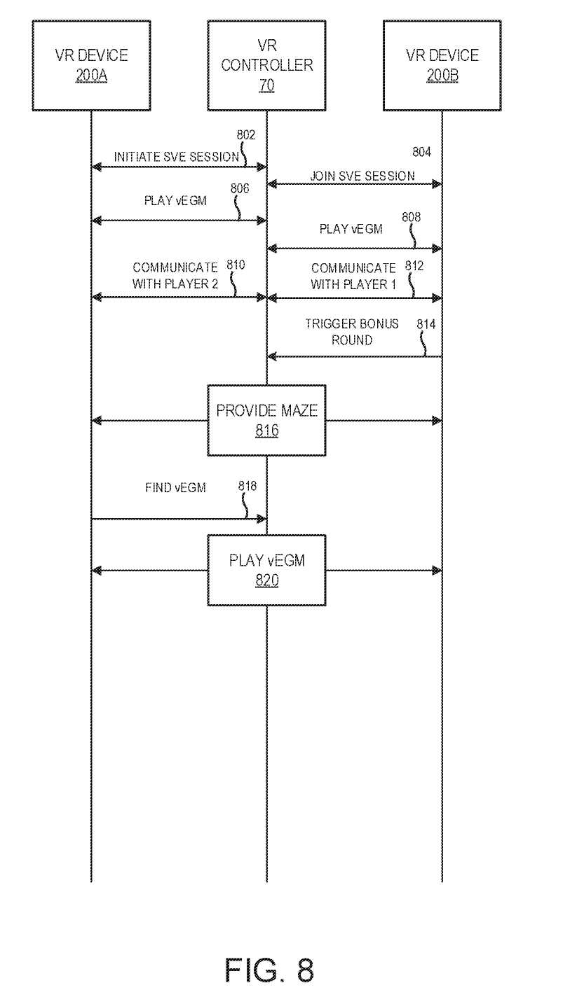

Reference is made to FIG. 8, which is a flow diagram illustrating message flows according to some embodiments. As illustrated, first and second VR devices 200A, 200B are in communication with a VR controller 70. The first VR device 200A may initiate a shared virtual environment (SVE) session via the VR controller 70 (arrow 802). Some embodiments provide that the VR device 200B corresponding to another player may join the SVE session (arrow 804). The SVE session may provide access to a bank of virtual electronic wagering game machines (vEGMs) that each of the players corresponding to VR devices 200A, 200B may select and play within the SVE session (arrows 806, 808). During the SVE session, the player corresponding to VR device 200A may communicate with another player (i.e., player associated with VR device 200B) (arrow 810). Similarly, the player corresponding to the VR device 200B may communicate with another player (i.e., player associated with VR device 200A) (arrow 812). Although illustrated and discussed as including two players in the SVE session, the disclosure herein contemplates a number of players other than two.

Any of the players may, during the course of playing the vEGM, may trigger a bonus round. For example, the player corresponding to VR device 200B may trigger a bonus round (arrow 814). In response to the bonus round being triggered, the VR controller 70 may provide a maze to each of the players in the SVE session (block 816). The maze may include one or more hidden vEGMs that the players may look for cooperatively. In some embodiments once one of the players finds the hidden vEGM, all of the players in the SVE session may play the vEGM 820 for a given time. Some embodiments provide that the player who finds the hidden bonus vEGM may be rewarded with an extra reward such as a progressive, extra time to play the bonus vEGM, and/or a wild reel and/or symbol, among others.

A Virtual EGM (vEGM)

An examples of virtual electronic gaming machine (vEGM) may come in many different shapes, sizes, layouts, form factors, and configurations, and with varying numbers and types of virtual input and output devices, and that embodiments of the inventive concepts are not limited to the particular vEGM features described herein.

The vEGMs and/or the bonus vEGM's may include virtual versions of any one of slot machines, card table, video poker, roulette, craps, and/or a cash grabber type game.

Like EGMs, vEGMs may include a number of standard virtual features such as a virtual support structure, housing or cabinet which provides virtual support for virtual displays, inputs, outputs, controls and other features that enable a player to interact with the vEGM.

For example, a vEGM may include virtual display devices, including a primary virtual display device located in a central portion of the virtual cabinet and a secondary virtual display device located in an upper portion of the virtual cabinet. The primary and secondary virtual display devices may be combined into a single virtual display device. The vEGM may further include a virtual credit display and a virtual bet display. The virtual credit display displays a player's current number of credits, cash, account balance or the equivalent. The virtual bet display displays a player's amount wagered.

The vEGM may further include a number of virtual input devices that allow a player to provide various inputs to the vEGM, either before, during or after a game has been played. For example, the vEGM may include a plurality of virtual input buttons that allow the player to select options before, during or after game play. The vEGM may further include a virtual game play initiation button and a virtual cashout button. The virtual cashout button is utilized to receive a payment corresponding to a quantity of remaining credits of a virtual credit display.

In some embodiments, one or more virtual input devices of the vEGM are one or more virtual game play activation devices that are each used to initiate a play of a game on the vEGM or a sequence of events associated with the vEGM following appropriate funding of the vEGM. A vEGM may include a virtual game play initiation button. It should be appreciated that, in other embodiments, the vEGM begins game play automatically upon appropriate funding rather than upon utilization of the virtual game play activation device.

In some embodiments, one or more virtual input devices of the vEGM are one or more virtual wagering or betting devices. One such virtual wagering or betting device is as a maximum wagering or betting device that, when utilized, causes a maximum wager to be placed. Another such virtual wagering or betting device is a repeat the bet device that, when utilized, causes the previously-placed wager to be placed. A further such virtual wagering or betting device is a virtual bet one device. A bet is placed upon utilization of the virtual bet one device. The bet is increased by one credit each time the bet one device is utilized. Upon the utilization of the virtual bet one device, a quantity of credits shown in a virtual credit display (as described below) decreases by one, and a number of credits shown in a virtual bet display (as described below) increases by one. In some embodiments, one or more of the virtual display screens may include a virtual touch-sensitive display.

The virtual display devices are generally configured to display one or more game and/or non-game images, symbols, and indicia. In certain embodiments, the virtual display devices of the vEGM are configured to display any suitable visual representation or exhibition of the movement of objects; dynamic lighting; video images; images of people, characters, places, things, and faces of cards; and the like. In certain embodiments, the virtual display devices of the vEGM are configured to display one or more virtual reels, one or more virtual wheels, and/or one or more virtual dice.

The vEGM also includes various virtual features that enable a player to deposit credits in the vEGM and withdraw credits from the vEGM, such as in the form of a payout of winnings, credits, etc. For example, the vEGM may include virtual representations of a ticket dispenser, a bill/ticket acceptor, and a coin acceptor. The vEGM may also include a virtual note dispenser configured to dispense paper currency and/or a virtual coin generator configured to dispense coins or tokens in a virtual coin payout tray.

The vEGM may play audio and display attractive multimedia images displayed on one or more of the virtual display devices audio-visual representation or to otherwise display full-motion video with sound to attract other players in the SVE to the vEGM and/or to engage the player during gameplay. In certain embodiments, the vEGM may display a sequence of audio and/or visual attraction messages during idle periods to attract potential players in the SVE to the vEGM. The videos may be customized to provide any appropriate information.

In some other embodiments, an vEGM may be implemented as a desktop computer, a laptop personal computer, a personal digital assistant (PDA), portable computing device, or other computerized platform. In some embodiments, the vEGM may be a virtual hand held device or a virtual mobile device.

Player Tracking

In various embodiments, the gaming system includes one or more player tracking systems under control of the player tracking server 45 shown in FIG. 1. Such player tracking systems enable operators of the gaming system (such as casinos or other gaming establishments) to recognize the value of customer loyalty by identifying frequent customers and rewarding them for their patronage. Such a player tracking system is configured to track a player's gaming activity. In one such embodiment, the player tracking system does so through the use of virtual player tracking cards. In this embodiment, a player is issued a virtual player identification card that that uniquely identifies the player. The gaming system timely tracks any suitable information or data relating to the identified player's gaming session. The gaming system also timely tracks when the virtual player tracking card is removed to conclude play for that gaming session. In such embodiments, during one or more virtual gaming sessions, the gaming system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In various embodiments, such tracked information and/or any suitable feature associated with the player tracking system is displayed on a player tracking display. In various embodiments, such tracked information and/or any suitable feature associated with the player tracking system is displayed via one or more service windows that are displayed on the central display device and/or the upper display device. At least U.S. Pat. Nos. 6,722,985; 6,908,387; 7,311,605; 7,611,411; 7,617,151; and 8,057,298 describe various examples of player tracking systems.

In some embodiments in which the gaming system includes: a central server, central controller, or remote host through a data network; and/or a plurality of VR devices configured to communicate with one another through a data network, the data network is an internet or an intranet. It should be appreciated that the central server, central controller, or remote host and the VR device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of VR devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

Examples of implementations of Internet-based gaming are further described in U.S. Pat. No. 8,764,566, entitled “Internet Remote Game Server,” and U.S. Pat. No. 8,147,334, entitled “Universal Game Server,” which are incorporated herein by reference.

### Further Definitions and Embodiments

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A computer implemented method comprising:
providing a real-time environmental model of a shared virtual environment (SVE) that includes a plurality of virtual electronic wagering game machines (vEGMs);
transmitting VR data corresponding to the SVE to a virtual reality (VR) device that is associated with a player, the VR data including user display data that causes a display in the VR device to render a portion of the SVE based on a virtual orientation of the VR device and a virtual location of the VR device in the SVE;
receiving, from the VR device, tracking information that is generated by a plurality of sensors that are configured to provide information corresponding to a motion or action by the player;
causing a virtual interaction between the player and the vEGM based on the tracking information; and
responsive to receiving the tracking information, transmitting updated VR data that causes the display to display the virtual interaction with one of the vEGMS in the SVE.

2. The method according to claim 1,
wherein the player comprises a plurality of players that play respective ones of the plurality of vEGMs via the tracking information,
wherein the plurality of players are represented in the SVE by respective ones of a plurality of avatars, and
wherein the VR device includes a microphone and a speaker that provide two-way audio communication between ones of the plurality of players while playing the vEGMs in the SVE.

3. The method according to claim 2, wherein the tracking information includes data corresponding to a direction that a corresponding one of the plurality of players is facing within the SVE, and
wherein the VR data causes the display to display a visual image of one or more of the plurality of avatars in the SVE based on the tracking information.

4. The method according to claim 2, wherein responsive to one of the plurality of players triggering a bonus round in the respective one of the plurality of vEGMS in the SVE, causing other ones of the plurality of players to be in the bonus round with the one of the plurality of players that triggered the bonus round.

5. The method according to claim 4, wherein which other ones of the plurality of players are included in the bonus round is determined based on at least one of an amount of wagering during a given time period before the bonus is triggered, a random selection, and a player tracking score corresponding to wagering activity of the respective one of the plurality of players.

6. The method according to claim 4, wherein the SVE comprises a bonus SVE that is provided to each of the plurality of players in the bonus round via the VR device.

7. The method according to claim 6, wherein the bonus SVE corresponds to a theme of the vEGM that the one of the plurality of players triggering a bonus game was playing when the bonus round was triggered.

8. The method according to claim 6, wherein the bonus SVE comprises a maze that each of the plurality of players in the bonus SVE can cause their respective ones of the plurality of avatars to navigate using an input device that is associated with the VR device.

9. The method according to claim 8, wherein the bonus SVE includes a bonus vEGM that is hidden in the maze, wherein visual and audio communication is provided between each of the plurality of players in the bonus SVE to collaborate with one another to locate the bonus vEGM that is hidden in the maze.

10. The method according to claim 9, wherein responsive to any of the plurality of players in the bonus SVE locating the bonus vEGM that is hidden in the maze, each of the plurality of players in the bonus SVE are awarded games to play on the vEGM for a given time.

11. The method according to claim 9, wherein locating the bonus vEGM that is hidden in the maze comprises the avatar performing at least one of opening a door in the maze, ducking below an overhanging object in the maze, jumping onto an elevated surface in the maze, climbing a vertical structure in the maze, breaking through a wall in the maze, and falling into a hole structure in the maze.

12. The method according to claim 8, further comprise generating the maze responsive to the bonus round being triggered.

13. The method according to claim 8, wherein a difficulty of the maze is based on at least one of a payout potential of the bonus vEGM and the number of players in the bonus round.

14. The method according to claim 8, wherein the bonus vEGM includes a plurality of vEGMS that are hidden at different locations in the maze, and wherein a quantity of the plurality of vEGMS is based on the number of players in the bonus round.

15. The method according to claim 8, further comprising generating, within the SVE, audible and/or visual cues to ones of the plurality of players in the bonus round responsive to a location of ones of the plurality of avatars relative to the bonus vEGM in the maze.

16. The method according to claim 8, further comprising generating a plurality of virtual objects that are in the maze and that the plurality of players may interact with via the respective plurality of avatars,
wherein ones of the plurality of virtual objects include at least one of avatar attire, a tool, a weapon, a vehicle, a time extension award, and a maze modifier.

17. The method according to claim 2,
wherein the plurality of players are each located at different geographical locations from one another,
wherein the different geographical locations comprise different premises types,
wherein a first one of the plurality of players is in a first geographical location that includes a first premises type that is one of a residence, a casino, a restaurant, and an office building, and
wherein a second one of the plurality of players is in a second geographical location that includes a second premises type that is one of a residence, a casino, a restaurant, and an office building that is different from the first premises type.

18. The method according to claim 2, wherein one of the plurality of players is interacting with one of the vEGMS in the SVE via a communication channel between the VR device of the player and a computing device of a casino.

19. (canceled)

20. A system for providing a multi-player wagering game, the system comprising:
a memory;
a communication interface that is communicatively coupled to a virtual reality (VR) device;
a processor that is coupled to the memory and the communication interface and that is configured to:
provide an environmental model of a shared virtual environment (SVE) that includes a plurality of virtual electronic wagering game machines (vEGMs);
transmit VR data corresponding to the SVE to the VR device that is associated with a player, the VR data including user display data causes a display in the VR device to render a portion of the SVE based on a virtual orientation of the VR device and a virtual location of the VR device in the SVE;
receive, from the VR device, tracking information that is generated by a plurality of sensors that are configured to provide information corresponding to a motion or action of the player;
cause a virtual interaction between the player and the vEGM based on the tracking information; and
responsive to receiving the tracking information, transmit updated VR data that causes the display to display the virtual interaction with one of the vEGMS in the SVE.

21. A non-transitory computer readable medium comprising instructions configured to cause a processing device to execute a method of providing a multi-player wagering game, the method comprising:
transmitting virtual reality (VR) data corresponding to a shared virtual environment (SVE) that includes a virtual representation of a plurality of electronic gaming machines (vEGMs) to a virtual reality (VR) device that is associated with a player, the VR data including user display that data causes a display in the VR device to render a portion of the SVE based on a virtual orientation of the VR device and a virtual location of the VR device in the SVE;
receiving, from the VR device, tracking information that is generated by a plurality of sensors that are configured to provide information corresponding to a motion or action of the player;
causing a virtual interaction between the player and the vEGM based on the tracking information; and
responsive to receiving the tracking information, transmitting updated VR data that causes the display to display the virtual interaction with one of the vEGMs in the SVE.
